(19) United States
(12) Patent Application Publication
(10) Pub. No.: US 2008/0079311 A1
(43) Pub. Date: Apr. 3, 2008

(54) VEHICLE REGENERATIVE BRAKING SYSTEM AND METHOD

(75) Inventors: Michael Schneider, Bloomfield Twp, MI (US); John Joyce, West Bloomfield, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 11/464,547

(22) Filed: Aug. 15, 2006

(51) Int. Cl. B60T 8/64

(52) U.S. Cl. 303/152

(57) ABSTRACT

The present invention provides a regenerative system and method for determining the occurrence of a braking imbalance between at least two wheels. In the event of a braking imbalance a vehicle controller generates signals that cause a reduction in the regenerative braking force and a corresponding increase in friction braking force being applied to the vehicle wheels.

### TECHNICAL FIELD

The present invention relates to a vehicle system and method for controlling the application of vehicle regenerative braking.

### BACKGROUND

Conventional vehicle regenerative braking systems typically apply regenerative braking torque to the wheels of a single axle on the vehicle. It is commonly known that in some cases unbalanced braking may occur wherein the braking torque or force applied to one set of wheels varies from the braking force applied to a second set of wheels. In such cases, for example, when unbalanced braking occurs at the vehicle's front axle, it may affect the ability to steer the vehicle. Alternatively, when unbalanced braking occurs at the rear axle, the lateral friction of the rear tires may be affected.

The present invention was conceived in view of these and other disadvantages of conventional vehicle regenerative braking systems.

### SUMMARY

The present invention provides a vehicle system and method for controlling the application of regenerative braking. The present invention includes a vehicle having a first and a second wheel, wherein the first wheel is attached to a first axle and the second wheel is attached to a second axle. The vehicle includes a regenerative braking system for applying a regenerative braking force to at least the first wheel. A friction braking system is included for applying a friction braking force to at least the second wheel. A controller is included and is configured to determine an occurrence of a braking imbalance between the first and second wheels. The controller also detects turning of the vehicle and generates signals that cause a reduction in the regenerative braking force when the braking imbalance occurs. Optionally a corresponding increase in friction braking force may occur along with the reduction in regenerative braking force.

The method includes a method of operation for the vehicle. The method includes detecting whether a friction braking force is being applied to at least the second wheel. The method also includes detecting an application of a regenerative braking force being applied to at least the first wheel. The method further includes determining, through the use of a controller, an occurrence of a braking imbalance between the first and second wheels based on the friction and regenerative braking forces being applied to the first and second wheels. An additional step includes detecting steering of the vehicle. Another step includes generating signals, through the use of the controller, which cause a reduction in the regenerative braking force and, optionally, an increase in friction braking force until a braking balance is achieved between the first and the second wheels.

### BRIEF DESCRIPTION OF THE DRAWINGS

These and other features and advantages of the invention will be apparent from the following detailed description and the appendant claims, taken in conjunction with the accompanying drawings, in which:

FIG. 1 is a schematic representation of an exemplary vehicle in accordance with an embodiment of the present invention; and

FIG. 2 is a flow chart of a method for controlling a regenerative braking system according to an embodiment of the invention.

### DETAILED DESCRIPTION OF THE PREFERRED EMBODIMENT(S)

By way of example, a preferred system and methodology for implementing the present invention is described below. The provided system and methodology may be adapted, modified or rearranged to best-fit a particular implementation without departing from the scope of the present invention.

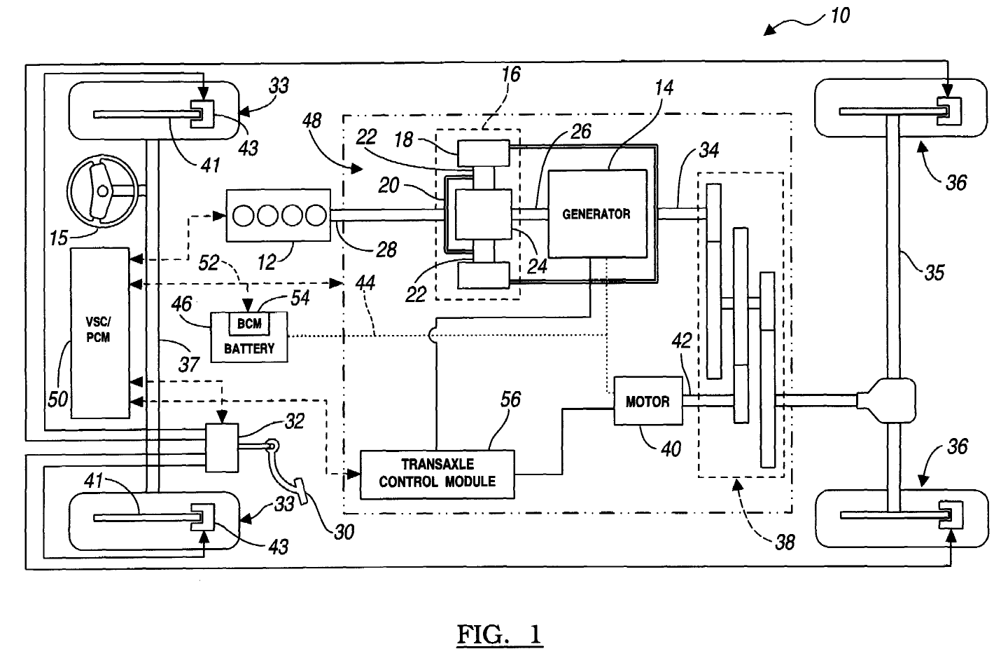

FIG. 1 illustrates a schematic representation of a vehicle 10 in accordance with one embodiment of the present invention. The vehicle 10 includes an engine 12 and an electric machine, or generator 14. The engine 12 and the generator 14 are connected through a power transfer unit, which in this embodiment is a planetary gear set 16. Of course, other types of power transfer units, including other gear sets and transmissions, may be used to connect the engine 12 to the generator 14. The planetary gear set includes a ring gear 18, a carrier 20, planet gears 22, and a sun gear 24.

The generator 14 can also be used as a motor, outputting torque to a shaft 26 connected to the sun gear 24. Similarly, the engine 12 outputs torque to a shaft 28 connected to the carrier 20. In one embodiment, the shaft 28 is comprised of two separate shafts that are coupled together by the damper (not shown). Having the generator 14 operatively connected to the engine 12, as shown in FIG. 1, allows the speed of the engine 12 to be controlled by the generator 14.

The ring gear 18 is connected to a shaft 34, which is connected to vehicle drive wheels 36 (i.e., rear wheels) through a second gear set 38. As recognized by one of ordinary skill, wheels 36 are mechanically connected to a rear axle 36 in a known manner. Additionally, a front axle 37 is mechanically connected to a set of front wheels 33 located on vehicle 10. Wheels 33 are responsive to a steering device 15, which is also connected to axle 37 via a steering shaft.

As recognized by one of ordinary skill, a steering sensor (not shown) may be included in the steering system of vehicle 10. The steering sensor is configured to sense the positioning and re-positioning of steering device 15. Accordingly, when a vehicle operator steers (i.e., positions or re-positions steering device 15) the vehicle 10, a steering command signal is generated through the use of steering device 15 and the steering sensor. As will be described hereinafter, a controller 50 receives and processes the steering command signal in accordance with the present invention.

It is also recognized that in alternative embodiments, the present invention may include steer-by-wire systems without departing from the scope of the present invention. Additionally, it is recognized that the steering system shown on vehicle 10 may include four wheel steering. In such an embodiment, depending upon the steering command signals, wheels 33 and 36 are both configured to respond to the vehicle operator's steering inputs. As used herein, the term “steering” includes, but is not limited to, a change in the vehicle's steered wheels in response to a driver's input. The term “turning” includes, but is not limited to, a change in the vehicle's direction, which may occur independent of the driver's input.

A friction braking system is located on vehicle 10, which includes a brake pedal 30, a braking distribution device 32, a brake disc 41, and a brake caliper 43. Upon engagement of the friction braking system via brake pedal 30, the braking distribution device 32 distributes braking fluid to each braking caliper 43. In response, the caliper 43 exerts braking forces on brake disc 41, thereby causing vehicle 10 to decrease speed or stop. Alternatively, the friction braking system may be embodied as a brake-by-wire system.

In the brake-by-wire embodiment, the braking distribution device 32 may have electronics integrated therein and function as a controller. Accordingly, the braking distribution device 32 generates signals that control the application of friction braking force to wheels 33 and 36. Particularly, in the event a reduction in regenerative braking force occurs, the braking distribution device 32 may generate signals that cause an increase in the applied friction braking force. In one aspect of the invention, the friction braking force is increased an amount that is substantially equal to the amount the regenerative braking force is reduced. Preferably, the increase in friction braking force occurs on an axle other than the axle upon which the regenerative braking force is reduced. It is also recognized that braking distribution device 32 may be configured to cause engagement of the friction braking system independently of whether the brake pedal is engaged.

Vehicle 10 also includes a second electric machine, or motor 40, which can be used to output torque to a shaft 42. Other vehicles within the scope of the present invention may have different electric machine arrangements, such as more or less than two electric machines. In the embodiment shown in FIG. 1, the motor 40 and the generator 14 which constitute, in part, a regenerative braking system can both be used as motors to output torque. Additionally, motor 40 and generator 14 may function as generators and apply a regenerative braking torque or force to wheels 36. As will be described hereinafter, the regenerative braking forces applied to wheels 36 are received and processed by controller 50 so as to mitigate unbalanced braking between axles 35 and 37. Furthermore, motor 40 and generator 14 can each output electrical power to a high voltage bus 44 and to an energy storage device, or battery 46.

The battery 46 is a high voltage battery that is capable of outputting electrical power to operate the motor 40 and the generator 14. Other types of energy storage devices and/or output devices can be used with a vehicle, such as the vehicle 10. For example, a device such as a capacitor can be used, which, like a high voltage battery, is capable of both storing and outputting electrical energy. Alternatively, a device such as a fuel cell may be used in conjunction with a battery and/or capacitor to provide electrical power for the vehicle 10.

As shown in FIG. 1, the motor 40, the generator 14, the planetary gear set 16, and a portion of the second gear set 38 may generally be referred to as a transaxle 48. The transaxle 48 is analogous to a transmission in a conventional vehicle. Thus, when a driver selects a particular gear, the transaxle 48 is appropriately controlled to provide that gear. To control the engine 12 and the components of the transaxle 48—e.g., the generator 14 and motor 40—a control system, including a controller 50, is provided.

It is recognized that although the vehicle 10 is an HEV, it is understood that the present invention contemplates the use of other types of vehicles. In addition, although the vehicle 10 shown in FIG. 1 is a parallel-series HEV, the present invention is not limited to HEV's having such a “powersplit” configuration. Furthermore, it is recognized that the motor 40, the generator 14, and the transaxle 48 of vehicle 10 may be re-configured so as to enable the application of regenerative braking forces to wheels 33 and 36. In such a configuration regenerative braking forces may be applied to wheels 33 and 36 independently or simultaneously.

In both preferred and alternative embodiments, the controller 50 may be a combination vehicle system controller and powertrain control module (VSC/PCM). Although it is shown as a single hardware device, it may include multiple controllers in the form of multiple hardware devices, or multiple software controllers within one or more hardware devices.

A controller area network (CAN) 52 allows the controller 50 to communicate with the transaxle 48 and a battery control module (BCM) 54. Just as the battery 46 has the BCM 54, other devices controlled by the controller 50 may have their own controllers. For example, an engine control unit (ECU) may communicate with the controller 50 and may perform control functions on the engine 12. In addition, the transaxle 48 may include one or more controllers, such as a transaxle control module (TCM) 56, configured to control specific components within the transaxle 48, such as the generator 14 and/or the motor 40.

As stated above, controller 50 in combination with TCM 56 are configured to determine the occurrence of a braking imbalance between the braking forces being applied to wheels 33 and 36. The braking imbalance may be caused by an undesirable distribution of braking between wheels on opposite axles (e.g., axles 35 and 37). Upon determination of a braking imbalance, when the vehicle is traveling at or above a speed threshold (e.g., 10 miles per hour), controller 50 generates signals that cause a reduction in the amount of regenerative braking forces being applied to wheels 36 until a braking balance between the wheels 33 and 36 is achieved. Additionally, in combination with reducing the amount of regenerative braking force applied to one set of wheels (e.g., wheels 36 attached to axle 35), the friction braking force applied to wheels on another axle (e.g., wheels 33 attached to axle 37) may be increased to achieve the braking balance.

As shown in FIG. 1, controller 50 communicates with braking distribution device 32 to enable monitoring and control of friction braking being applied to wheels 33 and 36. In the event of a braking imbalance, controller 50 is capable of generating signals that cause a reduction in regenerative braking forces to achieve the braking balance. As described in the foregoing, controller 50 may also generate signals that cause an increase in friction braking forces in an amount that corresponds with the reduction in regenerative braking forces.

In one embodiment, controller 50 contains a braking distribution map that has data pertaining to levels of braking forces generated by the friction and regenerative braking systems. The braking distribution map provides a braking tolerance band that may be used to indicate and achieve a braking balance. In one aspect of the present invention, an acceptable braking balance includes a variance in the amount of friction and regenerative braking forces being applied to wheels 33 and 36.

Regarding the braking distribution map, which may be embodied as a table of data stored within controller 50, it includes data indicating ideal relative braking levels for the vehicle axles (i.e., axles 35 and 37). Accordingly, when the vehicle operator engages the friction brakes via brake pedal 30, the controller 50 determines whether a braking imbalance exists based on the ideal relative braking levels and/or braking tolerances as provided by the braking distribution map. Controller 50 then generates signals to obtain appropriate levels of regenerative braking and/or friction braking that will reduce braking imbalances between wheels 33 and 36. Additionally, it is recognized that in some embodiments, controller 50 may determine the presence of a braking imbalance irrespective of whether the brake pedal 30 is engaged, so long as the vehicle is traveling at a speed greater than the speed threshold.

In some cases of braking imbalance, the vehicle's steerability and stability may be affected. Thus, as stated above, controller 50 is adapted to receive and process steering command signals while determining whether a braking imbalance exists. In one aspect of the present invention, the steering command signals may be processed to determine a steering angle of at least one of the steering device 15 and wheels 33 (and wheels 36 in alternative embodiments). As such, the controller 50 may generate a time filtered value for the steering angle, which may be utilized by the controller 50 to determine how much turning is occurring in addition to determining whether the braking imbalance exist.

As indicated above, in conjunction with monitoring the application of regenerative and friction braking forces, the controller 50 detects and processes the steering command signals generated via the steering system. The steering command signals may be monitored to determine whether the vehicle 10 is actually turning. In such an embodiment, the controller 50 determines the existence of the braking imbalance when the vehicle 10 is entering or experiencing a turn as indicated by the steering command signals.

Furthermore, controller 50 may also detect steering or turning of the vehicle by determining and processing an angular rotation rate or lateral acceleration of the vehicle. The angular rotation rate or lateral acceleration may also indicate the vehicle's level of turning. In other aspects of the present invention, the turning may be detected by evaluating the speed difference between wheels on the same axle (e.g., axle 35 or 37). If a braking imbalance is detected based on the distribution of friction braking forces and the regenerative braking forces along with a detection of steering commands and/or vehicle turning, the controller 50 generates signals that cause a reduction in regenerative braking forces to achieve a braking balance. Optionally, in conjunction with the reduction in regenerative braking forces, the friction braking forces applied to an axle other than the axle receiving the regenerative braking forces may be increased.

In alternative embodiments, controller 50 may contain one or more braking function algorithms that also provide the braking tolerances for controller 50 to determine the existence of a braking imbalance and a desired braking distribution between wheels 33 and 36. In such an embodiment, controller 50 may have, in memory, a braking function embodied as a mathematical expression containing variables for vehicle speed, relative wheel speeds (i.e., for wheels 33 and 36), friction braking, regenerative braking, and steering angle. Based on calculations through the use of the braking function and the foregoing variables, the existence of a braking imbalance and an appropriate braking force distribution may be determined.

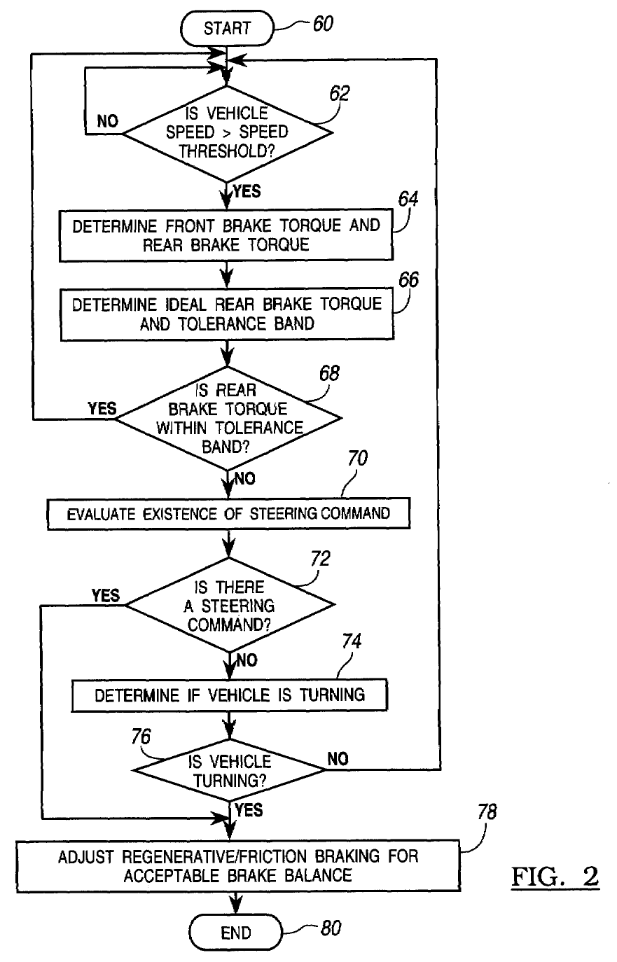

Referring now to FIG. 2, a flow diagram is provided that illustrates a method for determining and substantially reducing unbalanced braking. Block 60 is the entry point into the method. At block 62, the method determines whether the vehicle speed is greater than a determined speed threshold. If the vehicle speed is greater than the determined speed threshold, a block 64 occurs. At block 64, the method determines the amount of front brake torque or force and rear brake torque or force being exerted by the friction braking system and regenerative braking system.

As depicted by block 66, the method determines an ideal rear brake torque and the tolerance band for optimal levels of front and rear braking. As shown by block 68, the method determines whether the rear brake torque is within the tolerance band. In the embodiments shown, the rear wheels of the vehicle may be the set of wheels designated to receive regenerative braking. It is recognized, that in alternative embodiments, the vehicle may be configured to apply regenerative braking to the front wheels without departing from the scope of the present invention. Nevertheless, if the rear brake torque is within the tolerance band, the method returns to block 62. Alternatively, if the brake torque or force being applied to the rear wheels is not within the tolerance band, block 70 occurs.

At block 70, the controller evaluates the existence of a steering command. Accordingly, as depicted by block 72, the method determines whether or not a steering command is being generated by the vehicle operator. If a steering command is being generated by the operator, block 78 occurs wherein at least one of the regenerative braking and the friction braking is adjusted until an acceptable braking balance is achieved. In one embodiment, the regenerative braking is reduced at one axle while the friction braking being applied to an opposite axle is increased to achieve the braking balance.

However, if the steering command is not being generated, block 74 occurs wherein the method determines if the vehicle is actually turning. If the vehicle is turning, the block 78 occurs, wherein the regenerative braking and the friction braking are adjusted until an acceptable braking balance is achieved. If the vehicle is not turning, the method returns to block 62. Following block 78, the method ends at block 80.

While the best mode for carrying out the invention has been described in detail, those familiar with the art to which this invention relates will recognize various alternative designs and embodiments for practicing the invention as defined by the following claims.

What is claimed:

1. A vehicle having a first and a second wheel, wherein the first wheel is attached to a first axle and the second wheel is attached to a second axle, the vehicle comprising:
a regenerative braking system for applying a regenerative braking force to at least the first wheel;
a friction braking system for applying a friction braking force to at least the second wheel; and
a controller configured to determine an occurrence of a braking imbalance between the first and second wheels based on the friction and regenerative braking forces being applied to the first and second wheels, the controller detecting turning of the vehicle and generating signals that cause a reduction in the regenerative braking force at the first wheel when the braking imbalance occurs.

2. The vehicle of claim 1, wherein the controller generates signals that cause a reduction in regenerative braking force until a braking balance exists between the applied friction and regenerative braking force.

3. The vehicle of claim 1, wherein the controller generates signals that cause an increase in the applied friction braking force in an amount substantially equal to the reduction in the regenerative braking force.

4. The vehicle of claim 2, wherein the controller comprises a braking distribution map that provides corresponding levels of friction and regenerative braking for achieving the braking balance between the first and second axle, the controller determining the occurrence of a braking imbalance when the applied braking forces do not correspond with the braking force levels as provided by the braking distribution map.

5. The vehicle of claim 1, wherein the controller determines the occurrence of a braking imbalance upon the vehicle reaching a speed threshold.

6. The vehicle of claim 1, wherein the controller comprises a braking function in memory for providing a predetermined braking distribution for the friction and regenerative braking forces being applied to the first and second wheels, the controller, based on the braking distribution, determining the occurrence of the braking imbalance when the applied friction and regenerative braking forces do not correspond with the braking distribution as provided by the braking function.

7. The vehicle of claim 1, wherein the controller determines the occurrence of a braking imbalance between the first and second wheels based on the friction and regenerative braking forces being applied to the first and second wheels when the controller determines, based on a steering command generated upon steering of the vehicle, a steering angle that indicates the vehicle is entering or experiencing a turn.

8. The vehicle of claim 1, wherein the second axle has a first end and a second end, the first end having the second wheel attached thereto and the second end having a third wheel attached thereto, the controller detecting turning of the vehicle by evaluating differences in wheel speeds between the second and third wheels located on the axle.

9. The vehicle of claim 1, wherein the controller detects turning of the vehicle based on determining at least one of an angular rotation rate of the vehicle and a lateral acceleration of the vehicle.

10. The vehicle of claim 1, wherein the controller which detects the steering command includes a steering command that is detected by determining, via the controller, a steering angle, and based upon the steering angle, calculating a time filtered value of the steering angle that indicates an amount of turning being experienced by the vehicle.

11. The vehicle of claim 1, wherein the controller determines the occurrence of a braking imbalance by assessing relative wheel speeds of the first and the second wheels.

12. A vehicle having a front and a rear wheel, wherein the front wheel is attached to a first axle and the rear wheel is attached to a second axle, the vehicle comprising:
a friction braking system for applying a friction braking force to at least the front wheel;
a regenerative braking system for applying a regenerative braking force to at least the rear wheel; and
a controller configured to determine the occurrence of a braking imbalance between the front and rear wheels based on the friction and regenerative braking forces being applied to the front and rear wheels, the controller detecting turning of the vehicle and/or a steering command and generating signals that cause a reduction in regenerative braking force when the controller detects turning and/or the steering command and the braking imbalance.

13. The vehicle of claim 12, wherein the controller generates signals that cause a reduction in regenerative braking force on the second axle and a corresponding increase in friction braking forces on the first axle until a braking balance exists.

14. The vehicle of claim 12, wherein the controller comprises a braking distribution map that provides corresponding levels of friction and regenerative braking for achieving the braking balance between the first and second axle, the controller determining the occurrence of a braking imbalance when the applied braking forces do not correspond with the braking force levels as provided by the braking distribution map.

15. The vehicle of claim 12, wherein the controller comprises a braking function in memory for providing a predetermined braking distribution for the friction and regenerative braking being applied to the front and rear wheels, the controller, based on the braking distribution, determining the occurrence of the braking imbalance when the applied friction and regenerative braking forces do not correspond with the braking distribution as provided by the braking function.

16. The vehicle of claim 12, wherein the controller determines the occurrence of a braking imbalance between the front and rear wheels based on the friction and regenerative braking forces being applied to the front and rear wheels when the controller determines, based on the steering command signal, a steering angle that indicates the vehicle is entering or experiencing a turn.

17. The vehicle of claim 12, wherein the controller determines the occurrence of a braking imbalance between the front and rear wheels based on the friction and regenerative braking forces being applied to the front and rear wheels when the controller determines an angular rotation rate or lateral acceleration of the vehicle.

18. A method of operation for a vehicle having a first and a second wheel, wherein the first wheel is attached to a first axle and the second wheel is attached to a second axle, the method comprising:
detecting whether a friction braking force is being applied to at least the second wheel;
detecting an application of a regenerative braking force being applied to at least the first wheel;
determining, through the use of a controller, an occurrence of a braking imbalance between the first and second wheels based on the friction and regenerative braking forces being applied to the first and second wheels;
detecting steering of the vehicle; and
generating signals, through the use of the controller, based on the steering and the friction and regenerative braking forces, which cause a reduction in the regenerative braking force at the first wheel and an increase in friction braking force until a braking balance is achieved between the first and the second wheels.

19. The method of claim 18, wherein the controller comprises a braking distribution map that provides corresponding levels of friction and regenerative braking for achieving the braking balance between the first and second axle, the controller determining the occurrence of a braking imbalance when the applied braking forces do not correspond with the braking force levels as provided by the braking distribution map.

20. The method of claim 18, wherein the controller comprises a braking function in memory for providing a predetermined braking distribution for the friction and regenerative braking forces being applied to the first and second wheels, the controller, based on the braking distribution, determining the occurrence of the braking imbalance when the applied friction and regenerative braking forces do not correspond with the braking distribution as provided by the braking function.
